(19) United States
(12) Patent Application Publication
(10) Pub. No.: US 2026/0227592 A1
(43) Pub. Date: Aug. 6, 2026

(54) OPTICAL MAGNIFYING DEVICE

(71) Applicant: Far Vision Technology Co., Ltd., Taichung City (TW)

(72) Inventor: Hsi-Hsun CHEN, Taichung City (TW)

(73) Assignee: Far Vision Technology Co., Ltd., Taichung City (TW)

(21) Appl. No.: 19/374,447

(22) Filed: Oct. 30, 2025

(30) Foreign Application Priority Data
Feb. 3, 2025 (TW) 114201174

(51) Int. Cl. G02B 7/00; G02B 17/06

(52) U.S. Cl. CPC G02B 7/002; G02B 17/0615

(57) ABSTRACT

An optical magnifying device is adapted for reflecting a magnified image of an object to eyes of a user, and includes a support unit, a frame unit mounted to the support unit, and a mirror unit mounted to the frame unit. The frame unit includes two spaced apart support arms and a mounting arm connected between the support arms. The mirror unit includes an objective mirror set mounted to the support arms, and an ocular mirror set detachably mounted to the mounting arm and spaced apart from the objective mirror set. The ocular mirror set has a first positioning member detachably connected to the mounting arm. The mirror unit is configured to form an optical path forming the magnified image of the object and adapted to reflect the same to the eyes by the ocular mirror set.

### CROSS-REFERENCE TO RELATED APPLICATION

This application claims priority to Taiwanese Utility Model Patent Application No. 114201174, filed on February 3, 2025, the entire disclosure of which is incorporated by reference herein.

### FIELD

The disclosure relates to an optical device, and more particularly to an optical magnifying device for reflecting a magnified image of an object.

### BACKGROUND

A conventional anti-myopia reading mirror device disclosed in Chinese Utility Model Patent No. CN 218099783 U includes a support unit disposed on the ground, an ocular mirror set mounted on a top portion of the support unit and disposed above a desk, and an objective mirror set spaced apart from the ocular mirror set. The support unit includes a support arm, a mounting arm pivotably connected to an upper end of the support arm and provided for the ocular mirror set to be mounted thereto, and two connecting shafts pivotably connected to two opposite ends of the mounting arm and provided for the objective mirror set to be mounted thereto. The objective mirror set and the ocular mirror set are rotatably connected to each other through the connecting shafts. A user may place a book on a table top of the desk, and an image of the content of the book is reflected to the user’s eyes through the optical reflection between the objective mirror set and the ocular mirror set.

Although the conventional anti-myopia reading mirror device enables the user to read with an increased distance between the user and the book and ensures a proper reading posture, since a size and a curvature of each of the ocular mirror set and the objective mirror are specific for reading a book on the desk, the conventional anti-myopia reading mirror device is not applicable for scenarios other than reading books.

### SUMMARY

Therefore, an object of the present disclosure is to provide an optical magnifying device that can alleviate at least one of the drawbacks of the prior art.

According to an aspect of the disclosure, an optical magnifying device adapted for reflecting a magnified image of an object to eyes of a user is provided. The optical magnifying device includes a support unit, a frame unit, and a mirror unit. The frame unit is mounted to the support unit, and includes two support arms spaced apart from each other in a left-right direction, and a mounting arm extending in the left-right direction and connected to the support arms. The mirror unit is mounted to the frame unit, and includes an objective mirror set mounted to the support arms, and an ocular mirror set detachably mounted to the mounting arm, and spaced apart from the objective mirror set in a front-rear direction transverse to the left-right direction. The ocular mirror set has a first positioning member detachably connected to the mounting arm. The mirror unit is configured to form an optical path that forms the magnified image of the object and is adapted to reflect the magnified image of the object to the eyes of the user by the ocular mirror set.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an optical magnifying device of a first embodiment according to the present disclosure worn on a head of a user for viewing an object.

FIG. 2 is a perspective view of the first embodiment.

FIG. 3 is a partly exploded perspective view of the first embodiment seen from an angle different from FIG. 2.

FIG. 4 is a fragmentary partly exploded perspective view of the first embodiment.

FIG. 5 is a fragmentary partly exploded perspective view of the first embodiment seen from an angle different from FIG. 4.

FIG. 6 is a fragmentary sectional view of a mirror unit of the first embodiment.

FIGS. 7 to 10 are fragmentary sectional views of the mirror unit similar to FIG. 6 illustrating different use scenarios of the first embodiment.

FIG. 11 is a schematic side view of the first embodiment, illustrating that a counterweight unit of the first embodiment is adjustable.

FIG. 12 is a top sectional view taken along line XII-XII in FIG. 1.

FIG. 13 is a perspective view of a modification of the first embodiment.

FIG. 14 is a schematic perspective view of the optical magnifying device of a second embodiment according to the present disclosure worn on the head and a shoulder of the user.

FIG. 15 is a schematic side view of FIG. 14.

FIG. 16 is a schematic top view of FIG. 14.

FIG. 17 is a schematic side view of an optical magnifying device of a third embodiment according to the present disclosure disposed on a ground.

FIG. 18 is a perspective view of the third embodiment.

FIG. 19 is a schematic side view of an optical magnifying device of a fourth embodiment according to the present disclosure disposed on a desk.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

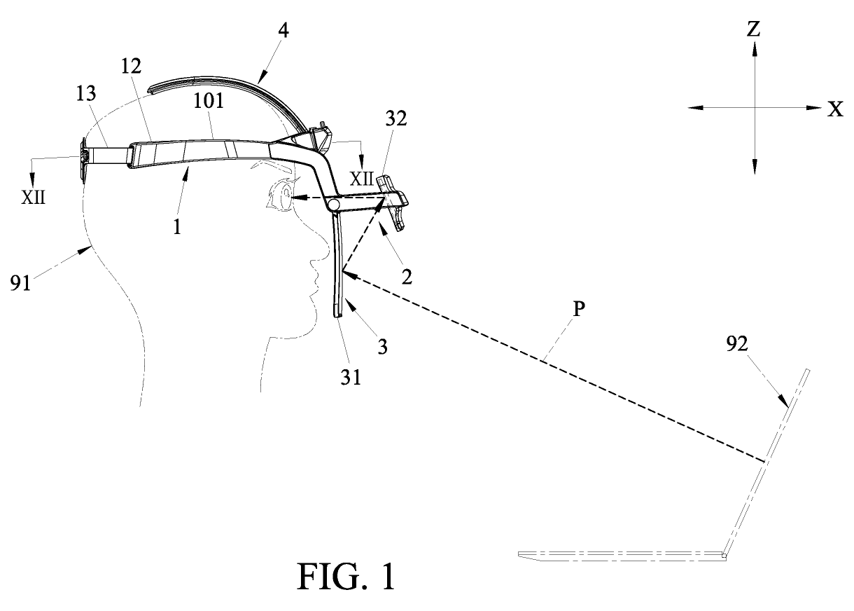

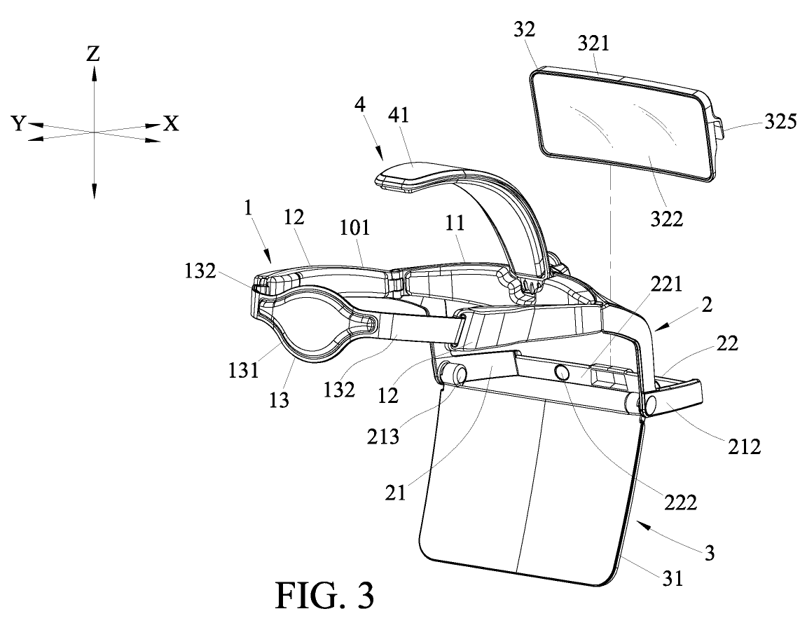

Referring to FIGS. 1 to 3, an optical magnifying device of a first embodiment according to the present disclosure is shown. The optical magnifying device is adapted to be worn on a head of a user 91 and is for reflecting an enlarged image of an object 92 to eyes of a user 91 to form a magnified image of the object 92. The optical magnifying device includes a support unit 1, a frame unit 2, a mirror unit 3, and a counterweight unit 4.

The support unit 1 includes a head frame 101. The head frame 101 is adapted to be worn on the head of the user 91 and surrounds and abuts against the head of the user 91. The head frame 101 includes a front frame bar 11 adapted for abutting against a forehead of the user 91, two lateral strips 12 spaced apart in a left-right direction (Y) and mounted to the front frame bar 11, and a headband 13 connected to the lateral strips 12 and adapted for abutting against a back of the head of the user 91. In this embodiment, the headband 13 includes a band body 131 and two fasteners 132 connected respectively to lateral sides of the band body 131. In some embodiments, the band body 131 is an elastic band or a non-woven fabric band, and each of the fasteners 132 is a hook and loop fastener that extends through a rear portion of a respective one of the lateral strips 12 to loop therearound and that is attached to itself to be connected to the head frame 101. In this way, a length of the headband 13 may be adjusted according to a circumference of the head of the user 91. In this embodiment, the head frame 101 further includes a plurality of pads 14 disposed on inner sides of the front frame bar 11 and the lateral strips 12. Each of the pads 14 is made of, e.g., a foam to provide a relatively soft touch and/or an anti-slip effect. In some embodiments, the headband 13 may be omitted from the head frame 101 and the lateral strips 12 are configured as glasses temples to be supported on ears of the user 91.

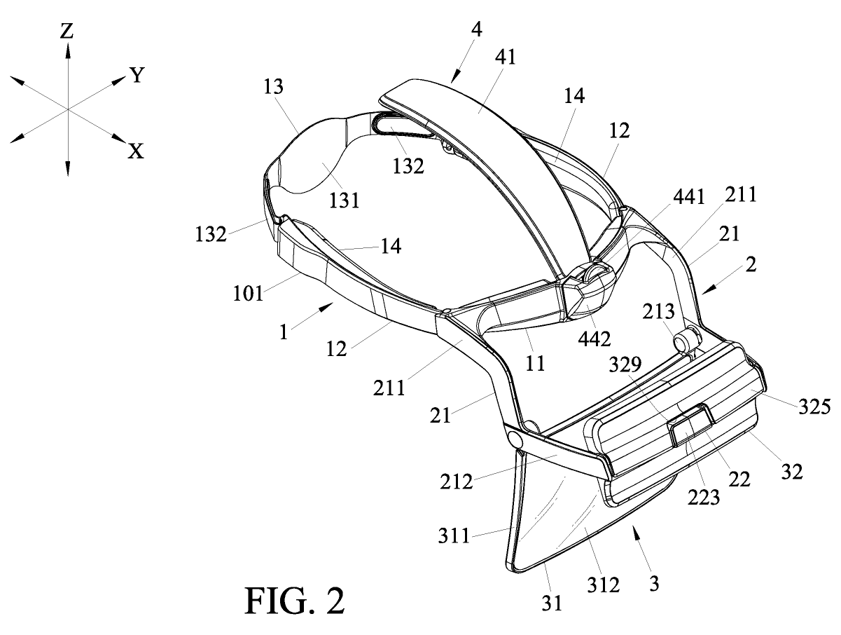

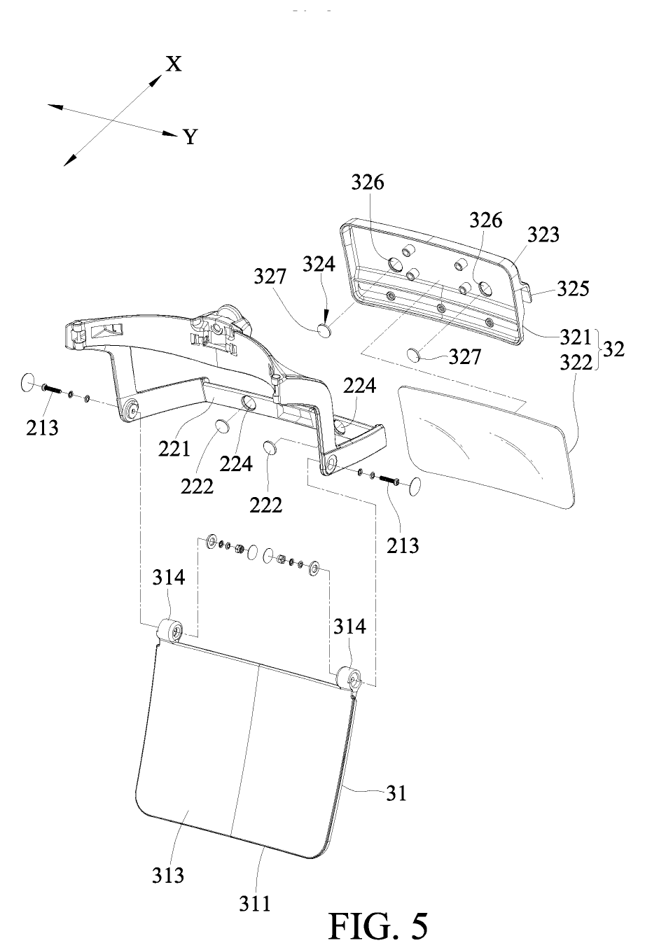

Referring to FIGS. 2, 4 and 5, the frame unit 2 is mounted to the support unit 1 in front of the head frame 101 in a front-rear direction (X) that is transverse to the left-right direction (Y), and includes two support arms 21 spaced apart from each other in the left-right direction (Y), and a mounting arm 22 extending in the left-right direction (Y) and connected to the support arms 21. Each of the support arms 21 has a connecting segment 211 connected to the front frame bar 11, an extension segment 212 connected to the connecting segment 211, and a pivot shaft 213 extending through the extension segment 212 in the left-right direction (Y). The mounting arm 22 has an arm segment 221, and at least one magnetic component 222 connected fixedly to the arm segment 221. In this embodiment, the arm segment 221 of the mounting arm 22 has a protrusion 223 that is rectangular and that protrudes forwardly in the front-rear direction (X), and two grooves 224 that are formed in an inner side of the arm segment 221, that are opposite to the protrusion 223 in the front-rear direction (X), and that are spaced apart from each other in the left-right direction (Y). In this embodiment, the at least one magnetic component 222 includes two magnetic components 222 spaced apart from each other in the left-right direction (Y) and connected respectively and fixedly to the grooves 224. In some embodiments, each of the magnetic components 222 is a magnet.

The mirror unit 3 is mounted to the frame unit 2, and includes an objective mirror set 31 mounted to the support arms 21 and extending in the left-right direction (Y), and an ocular mirror set 32 detachably mounted to the mounting arm 22 and spaced apart from the objective mirror set 31 in the front-rear direction (X). A total size of the ocular mirror set 32 is smaller than a total size of the objective mirror set 31, and a center position of the ocular mirror set 32 is higher than a center position of the objective mirror set 31 in an up-down direction (Z) transverse to the front-rear direction (X) and the left-right direction (Y).

The objective mirror set 31 is pivotably connected to the pivot shafts 213, such that the objective mirror set 31 is pivotable about the pivot shafts 213 relative to the object 92 (see FIG. 1) to change a tilt degree of the objective mirror set 31 relative to the object 92. The objective mirror set 31 includes an objective mirror holder 311 pivotably mounted to the pivot shafts 213, and a reflective mirror 312 connected fixedly to an outer side of the objective mirror holder 311 and facing the object 92. The reflective mirror 312 is, for example but not limited to, a convex mirror that has a free-form surface. In this embodiment, the objective mirror holder 311 includes a base body 313 and two pivot portions 314 that are disposed on an upper side of the base body 313, that are spaced apart in the left-right direction (Y) and that are pivotably and respectively mounted to the pivot shafts 213. In this embodiment, each of the pivot portions 314 is a hollow cylinder and the respective one of the pivot shafts 213 extends therethrough.

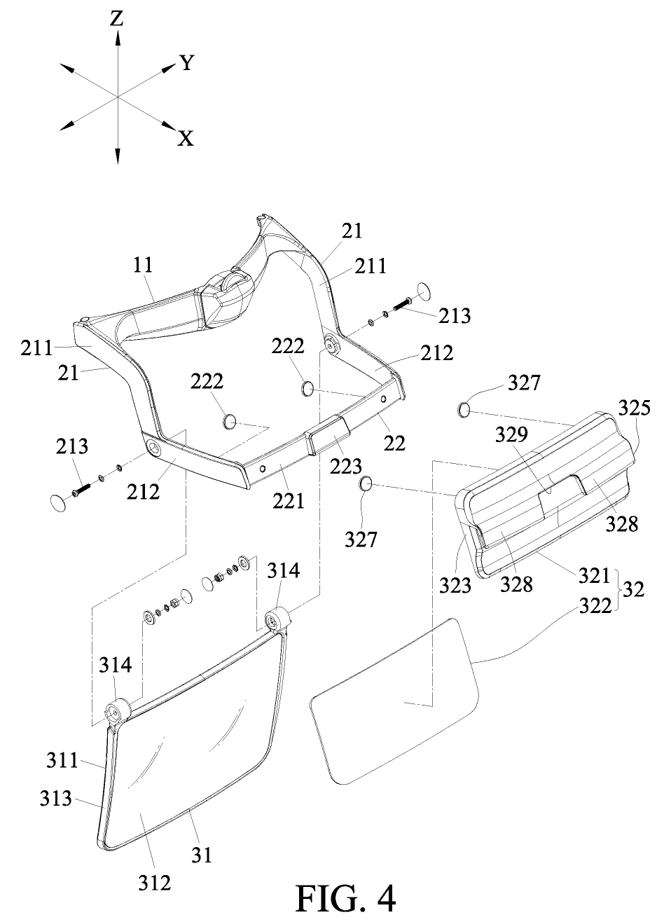

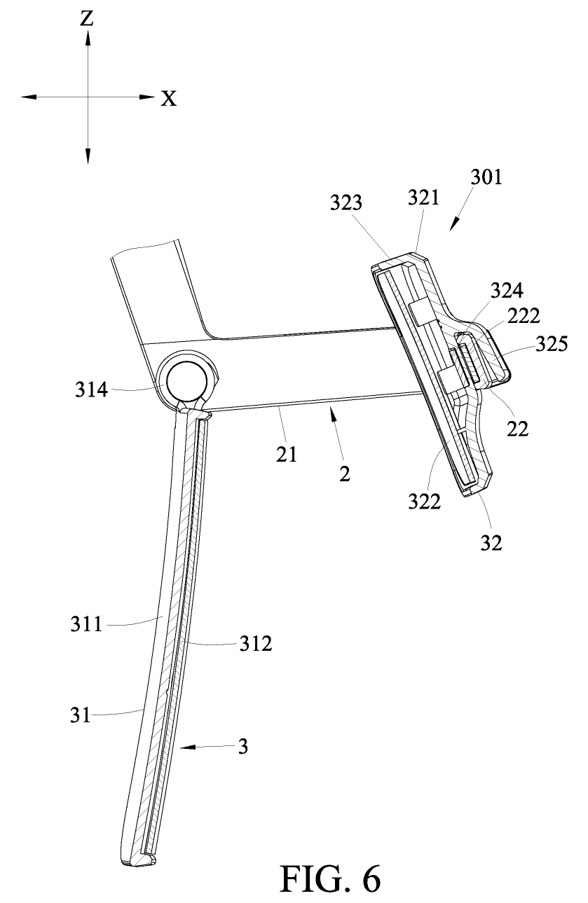

Referring to FIGS. 4 to 6, the ocular mirror set 32 has an ocular mirror seat 321 and a magnifying mirror 322 mounted on the ocular mirror seat 321 and facing the objective mirror set 31. The magnifying mirror 322 is, e.g., a concave mirror that has a free-form surface, and faces the reflective mirror 312. The ocular mirror seat 321 has a base body 323 provided for mounting of the magnifying mirror 322, a first positioning member 324 connected fixedly to the base body 323 and detachably connected to the mounting arm 22, and a second positioning member 325 extending from the base body 323 away from the support arms 21 of the frame unit 2 and detachably engaging the mounting arm 22. The base body 323 has two recesses 326 disposed between top and bottom sides of the base body 323 in the up-down direction (Z). In this embodiment, the first positioning member 324 has two magnets 327 disposed fixedly and respectively in the recesses 326, and respectively and magnetically attached to the magnetic components 222. It should be noted that the numbers of the magnets 327 and the magnetic components 222 are not limited to this example. In other embodiments, configurations of the first positioning member 324 and the magnetic component 222 may be modified as long as the ocular mirror set 32 is detachably connected to the mounting arm 22; for example, the first positioning member 324 may be a fastener detachably engaging the mounting arm 22. In this embodiment, the second positioning member 325 has two engaging plates 328 spaced apart in the left-right direction (Y), and a receiving groove 329 defined between the engaging plates 328 and engaging the protrusion 223. The engaging plates 328 engage the arm segment 221 of the mounting arm 22. As shown in FIG. 6, the pivot portions 314 are disposed at a height position between top and bottom sides of the ocular mirror set 32 in the up-down direction (Z).

In this embodiment, by virtue of the magnetic attraction among the magnetic component 222 and the magnets 327 and the engagement among the engaging plates 328 of the second positioning member 325 and the arm segment 221 of the mounting arm 22, the purpose of a detachable connection and a relatively strong stability of connection may be achieved. It can be appreciated that in some embodiments, either one of the magnetic attraction or the engagement may be used to achieve detachable connection of the ocular mirror set 32 and the mounting arm 22.

Referring back to FIG. 1, the mirror unit 3 is configured to form an optical path (P) extending from the object 92, reflected by the objective mirror 31 and then reflected by the ocular mirror set 32 to the eyes of the user 91 to form a magnified image of the object 92. In this way, the user 91 may see the magnified image of the object 92 on the ocular mirror set 32. By virtue of the mirror unit 3 that enlarges the image of the object 92, the user 91 may easily and clearly see the magnified image and maintain a correct posture, thereby avoiding forward tilting of the head.

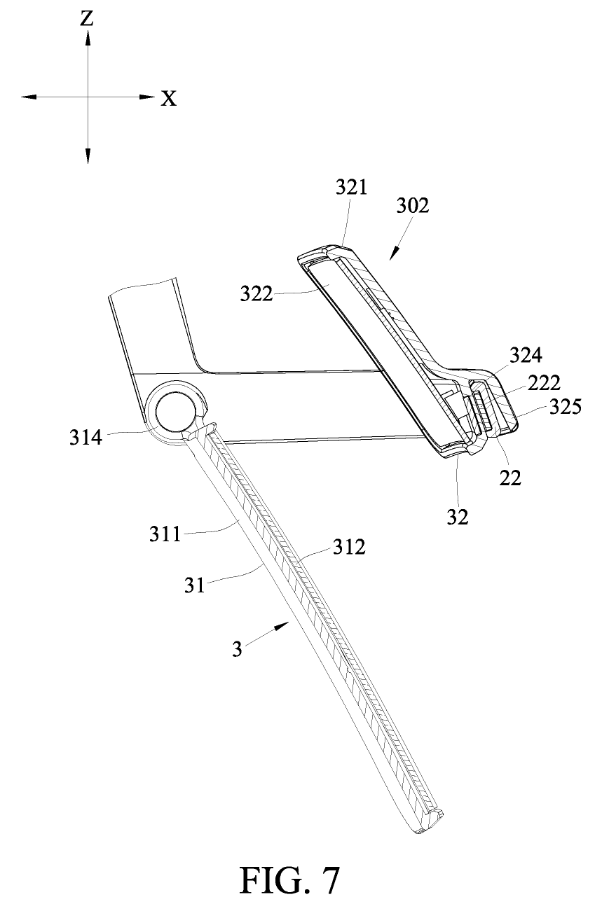

Referring to FIGS. 6 and 7, specifically, the ocular mirror set 32 includes a first ocular mirror set 301 and a second ocular mirror set 302. The first ocular mirror set 301 and the second ocular mirror set 302 have similar structures. The difference between the first ocular mirror set 301 and the second ocular mirror set 302 resides in that the a curvature and/or a size of the first ocular mirror set 301 is different from a curvature and/or a size of the second ocular mirror set 302. A selected one of the first ocular mirror set 301 and the second ocular mirror set 302 serves as the ocular mirror set 32 and is mounted to the mounting arm 22. As shown in FIG. 6, the mirror unit 3 in FIG. 6 is applicable to a situation of viewing a laptop disposed on a desk. In this example, the object 92 (see FIG. 1) is an assembly of a screen of the laptop that is disposed upright and a keyboard of the laptop that is disposed horizontally, and the first ocular mirror set 301 is mounted to the mounting arm 22. The mirror unit 3 in FIG. 7 is applicable to a situation of playing a piano, and the object 92 is an assembly of a sheet music and a keyboard (not shown in the drawing). As compared with FIG. 6, the objective mirror set 31 in FIG. 7 pivots about the pivot portions 314 such that a distal portion of the objective mirror set 31 that is opposite to the pivot portions 314 moves forwardly in the front-rear direction (X). Furthermore, the second ocular mirror set 302 is mounted to the mounting arm 22 and is moved upwardly and inclined rearwardly as compared with the first ocular mirror set 301 in FIG. 6.

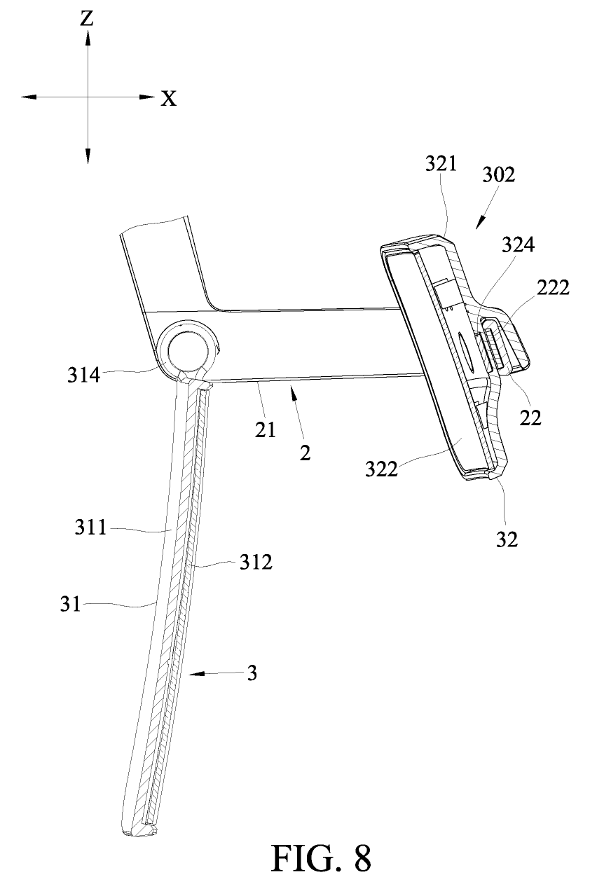

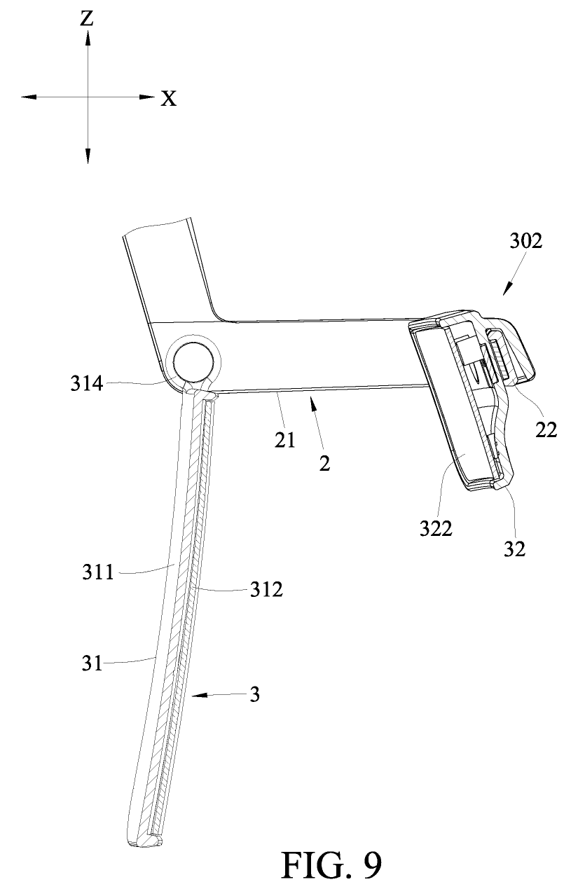

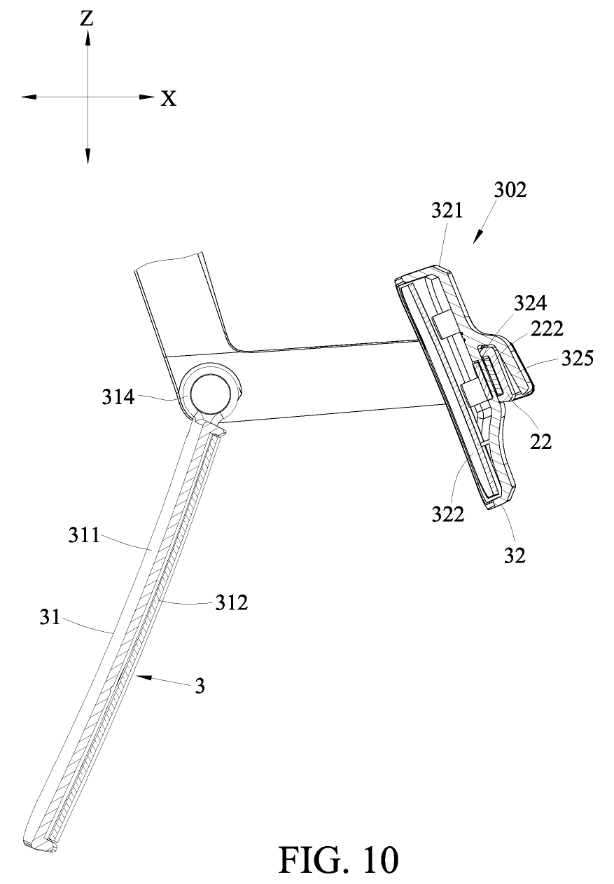

Referring to FIGS. 8 to 10, in some embodiments, the ocular mirror set 32 of the optical magnifying device includes a plurality of second ocular mirror sets 302 that have different curvatures and/or sizes. Thus, the user 91 (see FIG. 1) may select one of the first ocular mirror set 301 and the plurality of the second ocular mirror sets 302 and mount the same to the mounting arm 22 according to user requirements and a scenario of using the optical magnifying device. For example, the optical magnifying device shown in FIG. 8 is suitable to be used in a scenario of reading a book disposed on a desk. In this example, the second ocular mirror set 302 has a predetermined curvature, and the object 92, i.e., the book, is disposed horizontal. In another example, the optical magnifying device shown in FIG. 9 is for watching a large screen during a class, and a top portion of the second ocular mirror set 302 in FIG. 9 is shorter than that of the second ocular mirror set 302 used in FIG. 8 in the up-down direction (Z). In still another example, the optical magnifying device shown in FIG. 10 is for the user to look at a mobile phone disposed on the lap of the user 91 when the user 91 is seated. As compared with FIG. 6, the distal portion of the objective mirror set 31 in FIG. 10 pivots about the pivot portions 314 and moves rearwardly in the front-rear direction (X).

It should be noted that the optical magnifying device of the present disclosure may be further applied to various scenarios such as inspection of workpieces during manufacture and reading while lying down. Further details of these examples are omitted for the sake of brevity. In some embodiments, the objective mirror set 31 of the mirror unit 3 may be designed as a quick-release structure that may be detached easily.

It can be appreciated that an optimized curvature of each of the magnifying mirror 322 and the reflective mirror 312 may be calculated according to a position and an angle between the objective mirror set 31 and the ocular mirror set 32, a distance between the optical magnifying device and the object 92 in the front-rear direction (X), and a height of the object 92 in the up-down direction (Z). In this way, each of the magnifying mirror 322 and the reflective mirror 312 having an optimized curvature may be provided to achieve an optimized visual angle for comfortable viewing of the object 92. It should be noted that since the main feature of the present disclosure does not reside herein, further details of the same are not described for the sake of brevity.

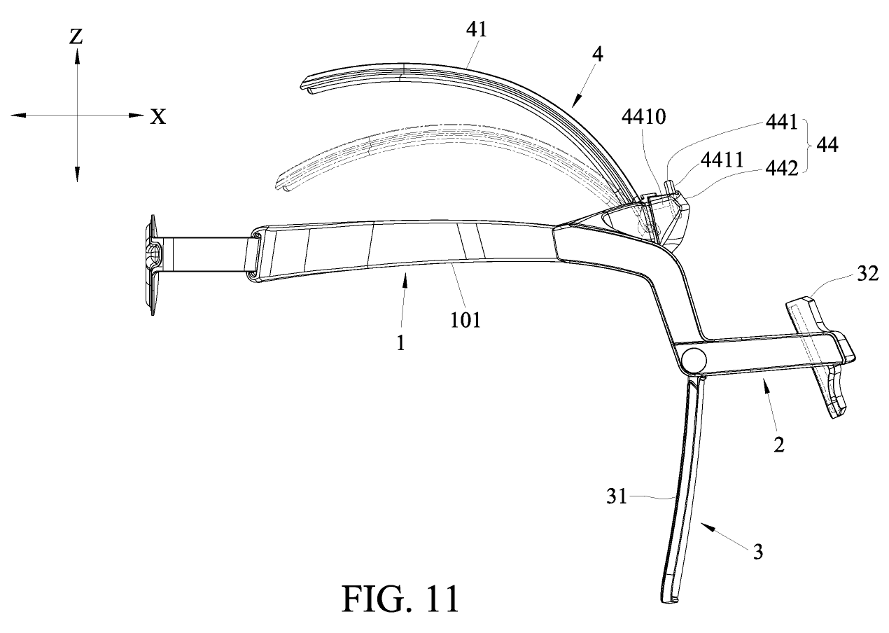

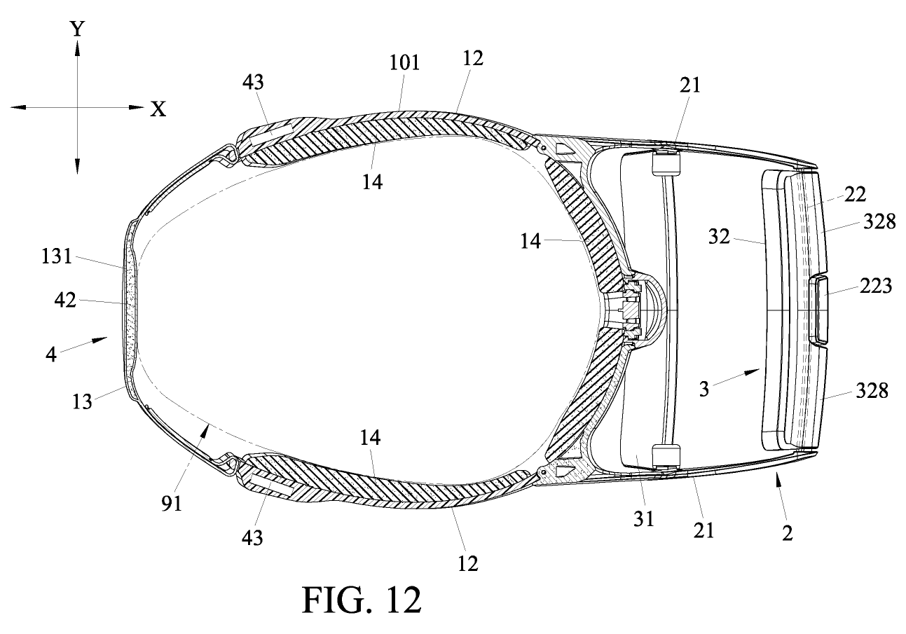

Referring to FIG. 11 and FIG. 12, the counterweight unit 4 is mounted to the support unit 1 to counteract the weight of the mirror unit 3. The counterweight unit 4 includes a top counterweight member 41, a rear counterweight member 42, two lateral counterweight members 43, and an adjustment assembly 44.

The top counterweight member 41 is disposed over an upper side of the support unit 1 in the up-down direction (Z), and extends from a front side of the front frame bar 11 (see FIG. 2) of the support unit 1 upwardly in the up-down direction (Z) and rearwardly in the front-rear direction (X). In this embodiment, the top counterweight member 41 extends from the front frame bar 11 of the head frame 101 upwardly and rearwardly. The rear counterweight member 42 is mounted to a rear side of the support unit 1 opposite to the front side of the support unit 1 in the front-rear direction (X). In this embodiment, the rear counterweight member 42 is disposed in the band body 131 of the headband 13. The rear counterweight member 42 includes iron sand, but is not limited hereto. The lateral counterweight members 43 are mounted respectively to two opposite sides of the support unit 1 in the left-right direction (Y), i.e., the lateral strips 12. In this embodiment, each of the lateral counterweight members 43 includes an iron sheet, but is not limited hereto.

The top counterweight member 41 has one end serving as a balancing point for the front frame bar 11, preventing the front frame bar 11 from sliding down due to the weight of the mirror unit 3. The rear counterweight member 42 mounted to the rear side of the support unit 1 cooperates with the lateral counterweight members 43 mounted respectively to the opposite sides of the head frame 101 to form a three-point support. Furthermore, the top counterweight member 41 also balances the head frame 101 in the up-down direction (Z) and in the front-rear direction (X). In this way, by virtue of the counterweight unit 4 that counteracts the weight of the mirror unit 3, the head frame 101, particularly the front frame bar 11, may be stably worn on the head of the user 91 and it is relatively difficult for the head frame 101 to slide down. As a result, a relatively comfortable wearing experience may be provided even when the user 91 tilts, turns, or raises his/her head and changes his/her posture. It can be appreciated that in other embodiments, the numbers of the top counterweight member 41, the rear counterweight member 42 and the lateral counterweight members 43 may be modified and positions of the same may also be adjusted. Furthermore, the weight and/or material of the counterweight unit 4 may also be changed, as long as the counterweight unit 4 is capable of counteracting the weight of the mirror unit 3.

Referring to FIG. 2 and FIG. 11, the adjustment assembly 44 is mounted to the support unit 1 and the top counterweight member 41. Specifically, the adjustment assembly 44 has an adjustment set 441 and a decorative cover 442. The adjustment set 441 is movable in the front-rear direction (X) and abuts against one end of the top counterweight member 41 to adjust a curvature of the top counterweight member 41. In this embodiment, the adjustment set 441 includes a threaded rod 4410 extending through the front frame bar 11 and abutting against the top counterweight member 41, and a plate body 4411 connected fixedly to the threaded rod 4410 and rotatable to move the adjustment set 441 in the front-rear direction (X). The decorative cover 442 is connected to the front frame bar 11 and covers a lower half of the plate body 4411 from a front side of the adjustment set 441. Thus, an upper half of the plate body 4411 is exposed from the decorative cover 442, making it convenient for the user 91 to adjust the curvature of the top counterweight member 41 by hand. In other embodiments, the adjustment assembly 44 may include a spring pin or other positioning fasteners.

By virtue of rotation of the plate body 4411 to move the adjustment set 441 in the front-rear direction (X), a height in the up-down direction (Z) of another end of the top counterweight member 41 that is opposite to the one end in the front-rear direction (X) and the curvature of the top counterweight member 41 may be adjusted. Thus, the user 91 may adjust the top counterweight member 41 to fit his/her head shape to improve wearing comfort.

It may be appreciated that in some embodiments, the counterweight unit 4 is omitted, and the head frame 101 may be securely worn on the head of the user 91 by the headband 13 that is adjustable to fit the head of the user 91.

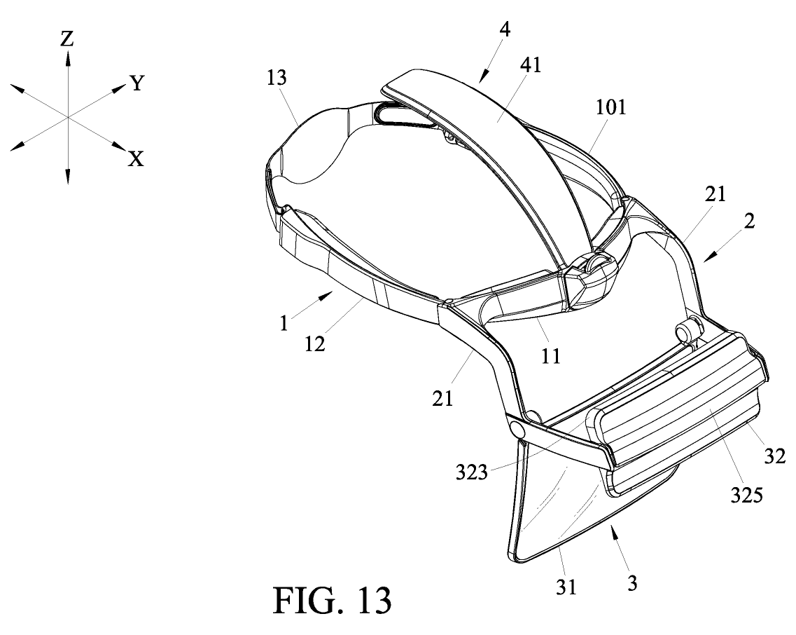

Referring to FIG. 13, a modification of the ocular mirror set 32 and the frame unit 2 is shown. The main differences between the modification and the embodiment shown in FIGS. 1 to 12 reside in that the second positioning member 325 of the ocular mirror set 32 is a continuous plate extending in the left-right direction (Y), the second positioning member 325 and the base body 323 have substantially the same length in the left-right direction (Y), and the protrusion 223 and the receiving groove 329 shown in FIG. 4 are omitted from the frame unit 2. In this modification, the ocular mirror set 32 may also be detachably mounted to the mounting arm 22 (see FIG. 4).

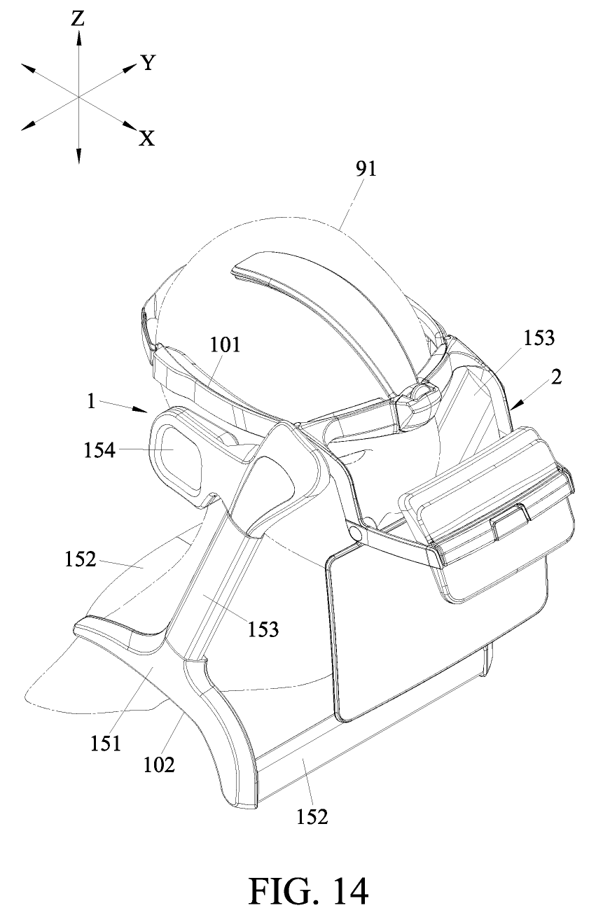

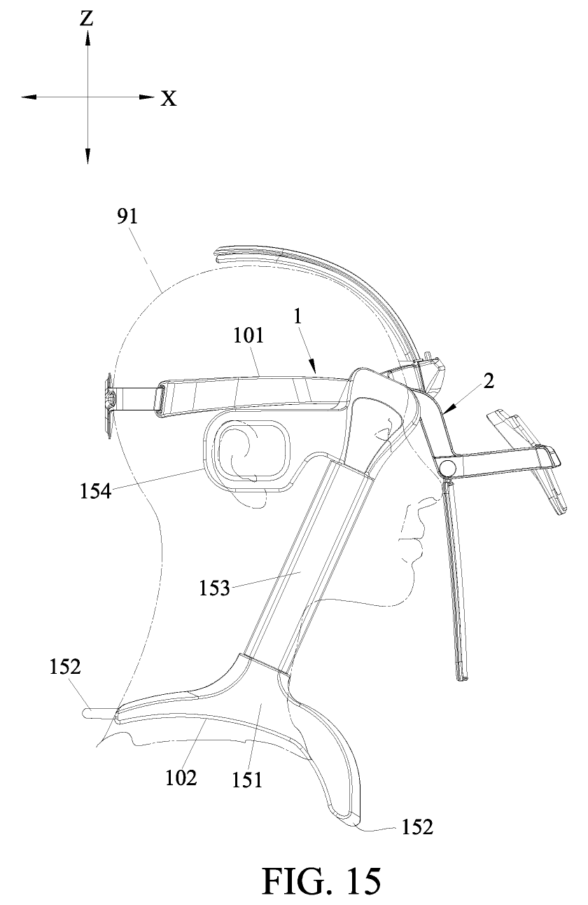

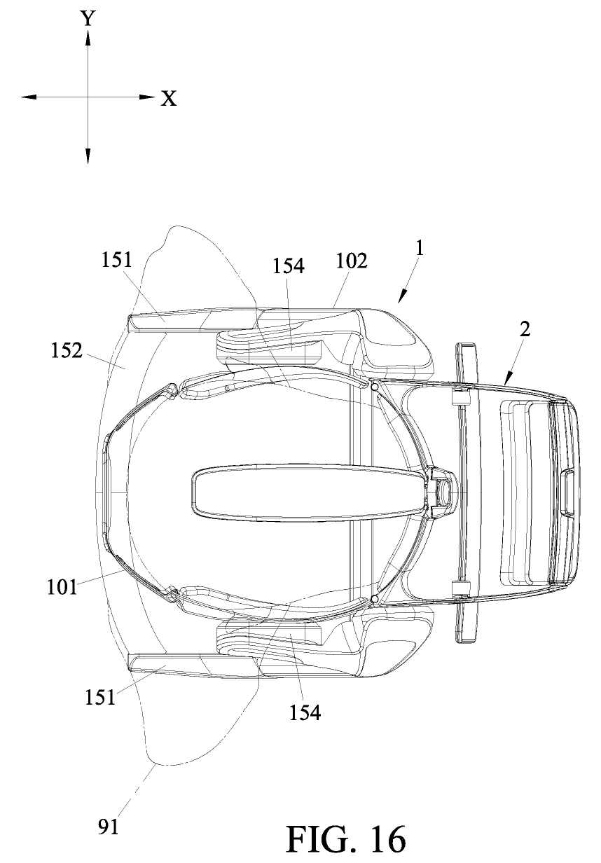

Referring to FIGS. 14 to 16, an optical magnifying device of a second embodiment according to the present disclosure is similar to the first embodiment, and the differences between the first embodiment and the second embodiment reside in the following.

In the second embodiment, the optical magnifying device is to be worn on the head of the user 91 and both shoulders of the user 91.

The support unit 1 further includes a shoulder stand 102 connected to the head frame 101 and the frame unit 2. It should be noted that in some embodiments, the shoulder stand 102 may be connected to either the head frame 101 or the frame unit 2. The shoulder stand 102 includes two shoulder arms 151 adapted for abutting against the shoulders of the user 91, two limiting arms 152 extending in the left-right direction (Y) and connected to the shoulder arms 151, two connecting arms 153 extending respectively and upwardly from the shoulder arms 151, and two ear pads 154 extending respectively and rearwardly from the connecting arms 153. The limiting arms 152 are adapted for abutting against a chest and a back of the user 91. The ear pads 154 are adapted for abutting against the ears of the user 91. The optical magnifying device is adapted to be supported on the shoulders, the head, the chest and the back of the user 91 by virtue of the shoulder stand 102, which not only reduces a load on the head of the user 91 but also improves the stability of the optical magnifying device when worn.

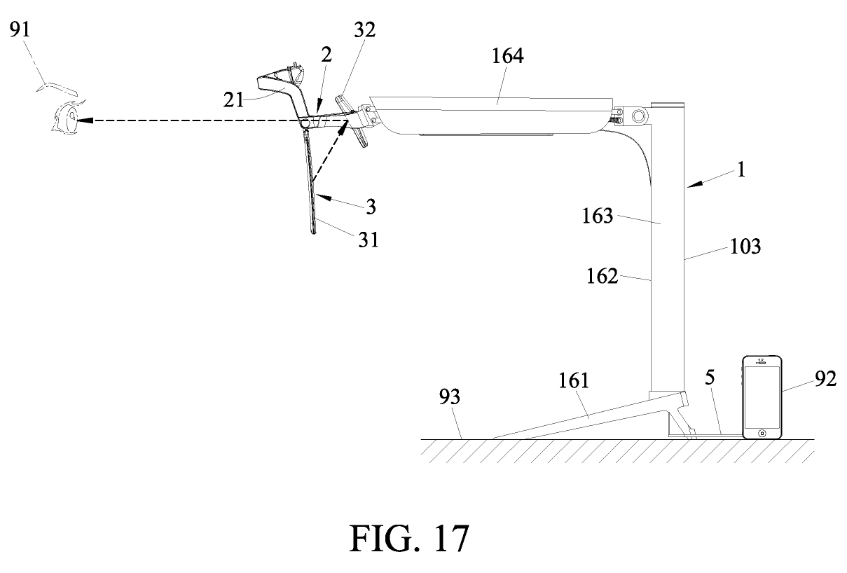

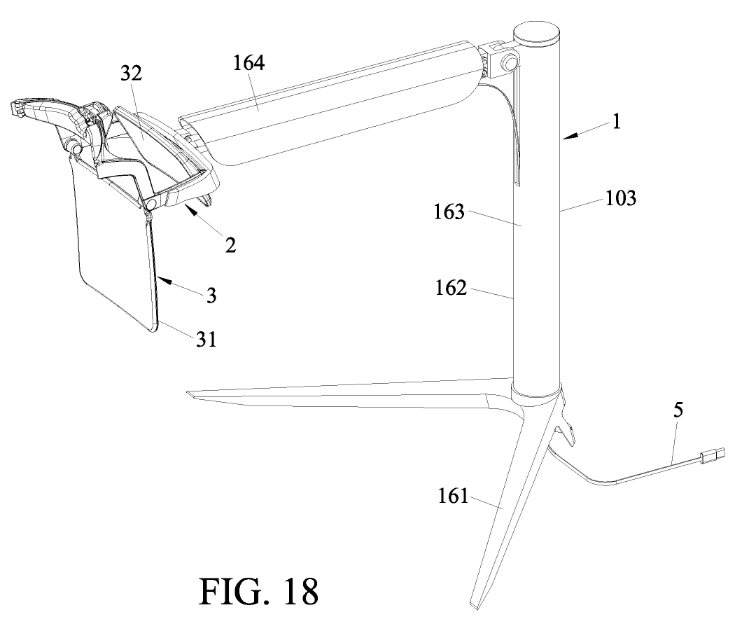

Referring to FIGS. 17 and 18, an optical magnifying device of a third embodiment according to the present disclosure is similar to the first embodiment, and the differences therebetween reside in the following.

The optical magnifying device of the third embodiment is to be placed on a ground 93.

In the third embodiment, the support unit 1 includes a stand 103. The stand 103 has a base seat 161 adapted to be disposed on the ground 93, and a frame body 162 extending upwardly from the base seat 161 in the up-down direction (Z) and connected to the frame unit 2. In this embodiment, the base seat 161 is a tripod. The frame body 162 is disposed in front of the eyes of the user 91 when the user 91 is using the optical magnifying device. Specifically, the frame body 162 includes an upright rod 163 extending upwardly from the base seat 161 and an extension rod 164 extending horizontally from a top portion of the upright rod 163. The extension rod 164 is provided for mounting of the frame unit 2 thereto.

In this embodiment, the optical magnifying device is communicatively connected to the object 92, e.g., a personal portable electronic device. In the third embodiment, the optical magnifying device further includes a transmission line 5 and the object 92 is a mobile phone communicatively connected to the optical magnifying device through the transmission line 5. The mirror unit 3 of the optical magnifying device of the third embodiment further includes an image projection module (not shown in the drawings) configured to project an image displayed on the mobile phone via the optical path to the ocular mirror set 32 such that a magnified image of the image displayed on the mobile phone is formed. It should be noted that the communication between the optical magnifying device and the object 92 is not limited to the example described herein; other wired or wireless transmission technologies may also be used in other embodiments of the present disclosure. Furthermore, since the structure of the image projection module and how the optical path is formed may be modified and are not the main features of the present disclosure, further details of the same will not be described for the sake of brevity.

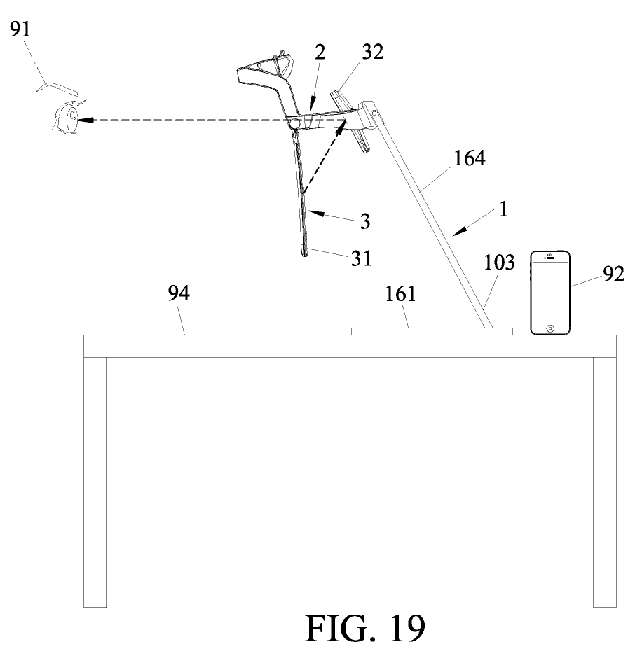

Referring to FIG. 19, an optical magnifying device of a fourth embodiment according to the present disclosure is similar to the third embodiment.

In the fourth embodiment, the optical magnifying device is to be placed on a table top 94 of a table.

The support unit 1 includes a stand 103 adapted to be disposed on the table top 94. The stand 103 has a base seat 161, and an extension rod 164 extending upwardly and inclinedly from the base seat 161 and connected to the frame unit 2. The user 91 may also see a magnified image of the object 92 on the ocular mirror set 32.

As described in the above embodiments, the support unit 1 of the present disclosure may be configured to have various structures and provide various functions, and may be designed to be a hanging type, a standing type, or a desktop type optical magnifying device.

To sum up, a selected one of the first ocular mirror set 301 and the second ocular mirror set(s) 302 of the ocular mirror set 32 may be mounted to the mounting arm 22 according to different use scenarios of the optical magnifying device. For example, the optical magnifying device is useful for the user 91 when reading book disposed on a desk, viewing a laptop, playing the piano, watching a large screen, lying down to read, seated and watching a mobile phone, or inspecting workpieces. The user 91 only needs to select an appropriate one of the first ocular mirror set 301 and the second ocular mirror set(s) 302 of the ocular mirror set 32 and mount the same to the mounting arm 22 through magnetic attraction among the magnets 327 of the first positioning member 324 and the magnetic components 222 of the mounting arm 22, and then optionally adjust an angle of the objective mirror set 31 relative to the ocular mirror set 32. Thus, the optical magnifying device assists the user 91 in maintaining a proper posture to view the magnified image of the object 92 through the mirror unit 3 without being affected by different use scenarios.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical magnifying device adapted for reflecting a magnified image of an object to eyes of a user, said optical magnifying device comprising:
a support unit;
a frame unit that is mounted to said support unit, and that includes two support arms spaced apart from each other in a left-right direction, and a mounting arm extending in the left-right direction and connected to said support arms; and
a mirror unit that is mounted to said frame unit and that includes an objective mirror set mounted to said support arms, and an ocular mirror set detachably mounted to said mounting arm, and spaced apart from said objective mirror set in a front-rear direction transverse to the left-right direction, said ocular mirror set having a first positioning member that is detachably connected to said mounting arm, said mirror unit configured to form an optical path that forms the magnified image of the object and adapted to reflect the magnified image of the object to the eyes of the user by said ocular mirror set.

2. The optical magnifying device as claimed in claim 1, wherein:
said ocular mirror set includes a first ocular mirror set and at least one second ocular mirror set;
one of a curvature, a size and a combination thereof of said first ocular mirror set is different from one of a curvature, a size and a combination thereof of said at least one second ocular mirror set; and
a selected one of said first ocular mirror set and said at least one second ocular mirror set serves as said ocular mirror set and is mounted to said mounting arm.

3. The optical magnifying device as claimed in claim 1, wherein:
said mounting arm has at least one magnetic component;
said ocular mirror set has an ocular mirror seat, and a magnifying mirror mounted on said ocular mirror seat and facing said objective mirror set; and
said first positioning member is a magnetic member connected fixedly to said ocular mirror seat, and is magnetically attached to said at least one magnetic component.

4. The optical magnifying device as claimed in claim 1, wherein:
said ocular mirror set has an ocular mirror seat, and a magnifying mirror mounted to said ocular mirror seat and facing said objective mirror set;
said ocular mirror seat has a base body provided for mounting of said magnifying mirror and said first positioning member thereto, and a second positioning member extending from said base body away from said support arms of said frame unit and detachably engaging said mounting arm.

5. The optical magnifying device as claimed in claim 4, wherein:
said mounting arm of said frame unit has an arm segment;
said at least one magnetic component includes two magnetic components spaced apart from each other and connected fixedly to said arm segment; and
said first positioning member has two magnets respectively and magnetically attached to said two magnetic components.

6. The optical magnifying device as claimed in claim 5, wherein:
said arm segment of said mounting arm has a protrusion protruding forwardly in the front-rear direction;
said second positioning member has two engaging plates spaced apart in the left-right direction and a receiving groove defined between said two engaging plates and engaging said protrusion; and
said two engaging plates engage said arm segment of said mounting arm.

7. The optical magnifying device as claimed in claim 1, wherein:
said optical magnifying device further comprises a counterweight unit;
said counterweight unit includes a top counterweight member that is disposed over an upper side of said support unit in an up-down direction transverse to the left-right direction and the front-rear direction, and extending from a front side of said support unit upwardly in the up-down direction and rearwardly in the front-rear direction.

8. The optical magnifying device as claimed in claim 7, wherein:
said counterweight unit further includes a rear counterweight member and two lateral counterweight members;
said rear counterweight member is mounted to a rear side of said support unit opposite to said front side of said support unit in the front-rear direction; and
said two lateral counterweight members are mounted respectively to two opposite sides of said support unit in the left-right direction.

9. The optical magnifying device as claimed in claim 7, wherein:
said counterweight unit further includes an adjustment assembly mounted to said support unit and said top counterweight member;
said adjustment assembly has an adjustment set movable in the front-rear direction and abutting against said top counterweight member.

10. The optical magnifying device as claimed in claim 1, wherein:
said support unit includes a head frame adapted to be worn on a head of the user;
said head frame includes a front frame bar adapted for abutting against a forehead of the user and two lateral strips spaced apart and mounted to said front frame bar.

11. The optical magnifying device as claimed in claim 10, wherein:
said support unit further includes a shoulder stand connected to one of said head frame and said frame unit; and
said shoulder stand includes two shoulder arms adapted for abutting against shoulders of the user.

12. The optical magnifying device as claimed in claim 1, wherein:
said support unit includes a stand; and
said stand has a frame body connected to said frame unit and adapted to be disposed in front of the eyes of the user in the front-rear direction when the user is using said optical magnifying device.
